(19) United States
(12) Patent Application Publication
(10) Pub. No.: US 2014/0186079 A1
(43) Pub. Date: Jul. 3, 2014

(54) HEATING DEVICE, FIXING DEVICE, AND IMAGE FORMING APPARATUS

(71) Applicant: CANON FINETECH INC., Misato-shi (JP)

(72) Inventor: Hiroshi MORITA, Akishima-shi (JP)

(73) Assignee: CANON FINETECH INC., Misato-shi (JP)

(21) Appl. No.: 14/141,691

(22) Filed: Dec. 27, 2013

(30) Foreign Application Priority Data
Dec. 27, 2012 (JP) 2012-284326
Nov. 14, 2013 (JP) 2013-235527

(51) Int. Cl. G03G 15/20

(52) U.S. Cl. CPC G03G 15/20
USPC 399/329

(57) ABSTRACT

Provided is a heating device capable of suppressing a bias force toward a center in a longitudinal direction (center in a rotation axis direction) of a fixing film serving as a rotation member, thereby preventing film overlapping and sheet wrinkles. A sliding friction resistance in the rotation axis direction of a fixing film (118b) between the fixing film (118b) and a protrusion (118g) is set so that at least a sliding friction resistance in an end part in the rotation axis direction is larger than a sliding friction resistance in a region closer to a central part in the rotation axis direction than the end part.

### BACKGROUND OF THE INVENTION

1. Field of the Invention

The present invention relates to a heating device for heating an object, a fixing device including the heating device and fixing a toner image onto a sheet, and an image forming apparatus including the heating device, such as a copier, a printer, or a fax machine.

2. Description of the Related Art

In a fixing device serving as a heating device for nipping, conveying, heating, and pressurizing a sheet having an unfixed toner image formed thereon, thereby fixing the toner image onto the sheet, heat capacity of a heating member is minimized so as to enhance energy efficiency. Moreover, there has been proposed a fixing device capable of reducing energy (power) required for increasing the temperature of a heating member to a fixing operable temperature.

The fixing device includes, for example, a heating body such as a heater which is fixed and supported, a heat-resistant fixing film serving as a band-shaped rotation unit which rotates while being press-contacted with the heating body, and a pressure member such as a roller for bringing a sheet as a material to be heated into close contact with the heating body through intermediation of the fixing film. There has been proposed a fixing film heating system of heating and fixing an unfixed toner image formed on the surface of a sheet onto the surface of the sheet by imparting heat from the heating body to the sheet via the fixing film.

The fixing device of the fixing film heating system can use a heating body which rapidly increases in temperature and a thin film which has low heat capacity. Therefore, the fixing device has advantages in that power can be saved and a printing standby time period can be shortened (quick start can be realized), with the result that an increase in temperature in an image forming apparatus can be suppressed.

However, although power can be saved and the printing standby time period can be shortened (quick start can be realized) by adopting a thin film as the fixing film, wrinkles are formed on a sheet when the sheet is fixed and conveyed in some cases.

When the fixing is performed to small-sized sheets consecutively, a temperature difference is caused between a part through which the small-sized sheets pass and a part through which the small-sized sheets do not pass in a rotation axis direction of the pressure roller which is being driven. The temperature difference causes a rotation speed difference in the rotation axis direction of the fixing film which is rotated in association therewith, with the result that the fixing film is warped. The warp causes change in entry timing of a sheet leading edge in a longitudinal direction (rotation axis direction) of the fixing film with respect to a fixing nip part (abutment part between the fixing film and the pressure roller), resulting in wrinkles on the sheet.

Regarding countermeasures against the occurrence of wrinkles on a sheet, Japanese Patent Application Laid-Open No. H11-2977 discloses a technology of preventing warp of the fixing film by setting a gap between the fixing film and a support member in the fixing film (difference between an inner circumferential length of the fixing film and an outer circumferential length of the support unit) to be small.

However, the countermeasures against the occurrence of wrinkles disclosed by Japanese Patent Application Laid-Open No. H11-2977 are not enough, and in some cases, wrinkles may be formed on a sheet or a phenomenon may occur in which the fixing film is biased to the center thereof and is overlapped at the center (hereinafter referred to as “film overlapping”).

In Japanese Patent Application Laid-Open No. H11-2977, although a gap between the fixing film and the support unit supporting the fixing film (difference between the inner circumferential length of the fixing film and the outer circumferential length of the support member) is set to be small, special setting is not performed with respect to a gap between the fixing film and the support unit on an inner side of the fixing film in the longitudinal direction (rotation axis direction) of the fixing film.

In Japanese Patent Application Laid-Open No. H11-2977, as in Comparative Example 1 illustrated in FIG. 9, a protrusion 118g is provided only at a position opposed to a central part in a longitudinal direction (right and left direction of FIG. 9) of a fixing film 118b on an upper surface 118r of a heater stay 118f for supporting a heater 118a serving as a heating body.

In the configuration of FIG. 9, a gap between the fixing film 118b and the support unit is small in the central part (protrusion 118g), compared to that in end parts. This configuration causes film overlapping that is a phenomenon in which the fixing film 118b itself is biased to the center in the longitudinal direction when a sheet, to which the fixing is performed, passes or causes wrinkles which are a sign of film overlapping to occur on a sheet. Further, the configuration strengthens the force that causes the fixing film 18b to be biased to the center thereof in the longitudinal direction, resulting in that film overlapping and wrinkles on a sheet cannot be sufficiently prevented.

### SUMMARY OF THE INVENTION

In order to solve the above-mentioned problems, the present invention provides a heating device capable of preventing film overlapping and wrinkles on a sheet by suppressing a force that causes a fixing film serving as a rotation unit to be biased to the center in a longitudinal direction (rotation axis direction).

In order to achieve the above-mentioned object, according to one embodiment of the present invention, there is provided a heating device, including: a support unit; and a rotation unit having a band shape, rotating around the support unit, and heating an object, wherein a sliding friction resistance in a rotation axis direction of the rotation unit between the rotation unit and the support unit is set so that at least a sliding friction resistance in a first region in the rotation axis direction is larger than a sliding friction resistance in a second region closer to a central part in the rotation axis direction than the first region.

Further features of the present invention will become apparent from the following description of exemplary embodiments with reference to the attached drawings.

### BRIEF DESCRIPTION OF THE DRAWINGS

FIG. 1 is a sectional explanatory diagram illustrating a configuration of an image forming apparatus including a fixing device according to a first embodiment of the present invention.

FIG. 2 is a schematic sectional view illustrating a configuration of the fixing device according to the first embodiment.

FIG. 3 is a perspective explanatory diagram illustrating a configuration of protrusions protruding on an outer circumferential surface of a guide member of the fixing device according to the first embodiment.

FIG. 4A is a schematic sectional view of a central part of a fixing film, illustrating a state of the fixing film during rotation of a pressure member of the fixing device according to the first embodiment.

FIG. 4B is a schematic sectional view of the central part of the fixing film, illustrating a state of the fixing film during suspension of the pressure member of the fixing device according to the first embodiment.

FIG. 5 illustrates contraction amount of paper in the case where a sheet passing through the fixing device according to the first embodiment is paper.

FIG. 6 is a schematic view illustrating a relationship between a crown amount of a fixing nip part of a film guide serving as a guide member in the fixing device according to the first embodiment, and a gap between an inner circumferential surface of the fixing film and a guide surface (protrusion) of the guide member.

FIG. 7 illustrates a reversed crown amount in a longitudinal direction of the fixing film.

FIG. 8 is a graph illustrating relationships between the number of protrusions protruding on the outer circumferential surface of the guide member of the fixing device according to the first embodiment and the frequency of occurrence of film overlapping of the fixing film, compared to each other based on a thickness of the fixing film and presence/absence of reversed crown of the guide member.

FIG. 9 is a perspective explanatory diagram illustrating a configuration according to Comparative Example 1 in which a protrusion is provided on an outer circumferential surface of a guide member of a fixing device.

FIG. 10 illustrates a comparison of bias amounts in a longitudinal direction of a fixing film between the first embodiment and the Comparative Example 1.

FIG. 11 illustrates a comparison of bias forces in the longitudinal direction of the fixing film between the first embodiment and Comparative Example 2.

### DESCRIPTION OF THE EMBODIMENTS

An image forming apparatus including a fixing device according to an embodiment of the present invention is described specifically with reference to the drawings.

### First Embodiment

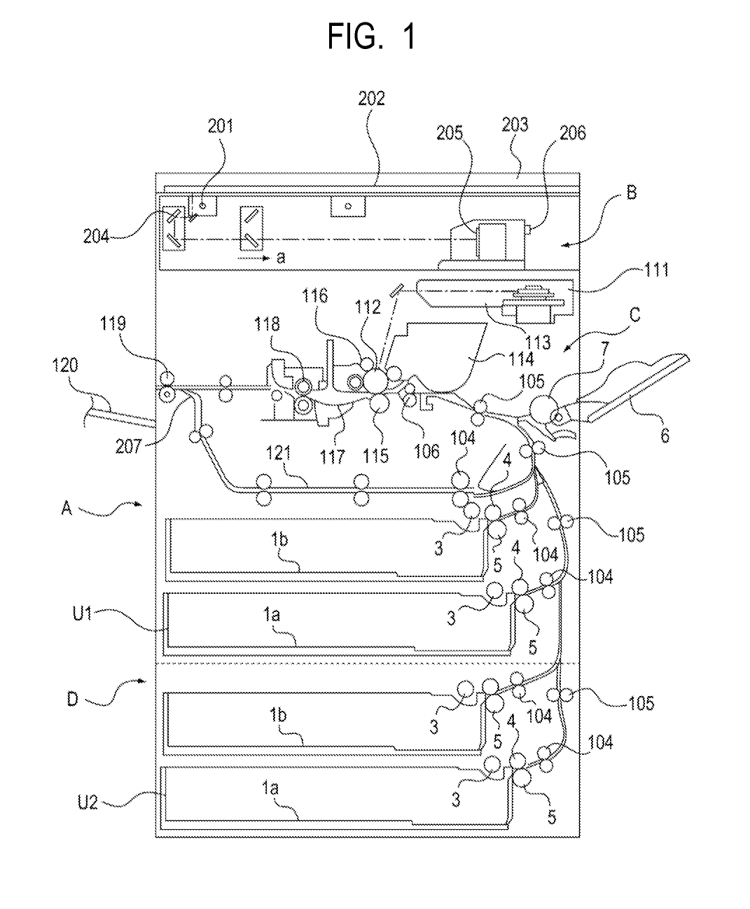

First, a configuration of an image forming apparatus including a fixing device serving as a heating device according to a first embodiment of the present invention is described with reference to FIGS. 1 to 5 and 9 to 11. FIG. 1 illustrates an example in which the present invention is applied to a copier serving as an image forming apparatus.

Image Forming Apparatus

FIG. 1 illustrates an entire configuration of the copier serving as the image forming apparatus according to the first embodiment. A scanner part B serving as an image reading unit for reading image information from a book original is disposed above an image forming apparatus main body A. An image forming part C serving as an image forming unit is provided below the scanner part B, and a sheet deck D is provided below the image forming part C.

The scanner part B includes a scanning system light source 201, a platen glass 202, an original pressure plate 203 capable of being opened/closed with respect to the image forming apparatus main body A, a mirror 204, a lens 205, a light-receiving element 206 made of a photoelectric converting element, an image processing part, and the like.

A book original such as a book or a sheet-shaped original is placed on the platen glass 202 with a original surface faced downward, and the back surface of the original is pressed by the original pressure plate 203 so that the original is set in a stationary state. When a read start key is pressed, the scanning system light source 201 scans the lower part of the platen glass 202 in a direction of an arrow “a” of FIG. 1 and reads image information from the original surface.

The original image information read by the scanning system light source 201 is processed in the image processing part and converted into an electric signal. The electric signal is transmitted to a laser scanner 111 of the image forming part C. The image forming apparatus main body A functions as a copier when a processing signal of the image processing part is input to the laser scanner 111 of the image forming part C, and functions as a printer when an output signal of an external device such as a computer is input. Further, the image forming apparatus main body A functions as a fax machine when a signal is received from another fax machine or a signal of the image forming part is transmitted to another fax machine.

A sheet cassette 1 is mounted on the image forming apparatus main body A and the sheet deck D. Two sets of a lower-stage cassette 1a and an upper-stage cassette 1b are provided in each of feed units U1 and U2, and a total of four sheet cassettes 1 are mounted on the image forming apparatus main body A and the sheet deck D.

The feed unit U1 disposed on an upper side of the sheet deck D is removably mounted on the image forming apparatus main body A, and the feed unit U2 disposed on a lower side of the sheet deck D is removably mounted on the sheet deck D.

Sheets received in the lower-stage cassette 1a and the upper-stage cassette 1b are picked up by a pickup roller 3 serving as a feed rotation member. Then, the sheets are separated and fed one by one owing to the coordinating function of a feed roller 4 and a retard roller 5, and thereafter, conveyed to registration rollers 106 by conveyance rollers 104, 105. The sheets are fed to the image forming part C in synchronization with the image forming operation by the registration rollers 106. Further, a manual feed tray 6 is disposed on a side surface side of the image forming apparatus main body A, separately from the sheet cassette 1, and sheets on the manual feed tray 6 are fed by a manual feed roller 7 to the registration rollers 106.

The image forming part C includes a photosensitive drum 112 serving as an image bearing member, the laser scanner 111, a charging roller 116, a developing device 114, a transfer roller 115, a fixing device 118, and the like. The laser scanner 111 scans the surface of the photosensitive drum 112, which is uniformly charged by the charging roller 116, with laser light corresponding to image information and output from the laser scanner 111, with the result that an electrostatic latent image is formed on the surface of the photosensitive drum 112. A toner is supplied to the electrostatic latent image and developed by the developing device 114. Thereby, a toner image is formed.

The toner image formed on the surface of the photosensitive drum 112 is transferred onto a first surface of a sheet sent from the registration rollers 106 in synchronization with the rotation of the photosensitive drum 112 in a transfer part in which the transfer roller 115 is disposed.

The sheet having the toner image formed thereon in the transfer part is conveyed by a conveyance part 117 and sent to the fixing device 118. The sheet is heated and pressurized in the fixing device 118, with the result that the toner image is fixed onto the sheet, and thereafter, the sheet is delivered by delivery rollers 119 onto a delivery tray 120 disposed outside of the apparatus.

In the case where an image is recorded on both surfaces of a sheet, the sheet discharged from the fixing device 118 is nipped by the delivery rollers 119. At a time point when a trailing edge of the sheet passes through a branch point 207, the delivery rollers 119 are rotationally driven in a reverse direction. Thus, the sheet is conveyed to a double-side conveyance path 121. After that, the sheet is conveyed again by the conveyance rollers 104, 105 and reaches the registration rollers 106 with the sheet being inverted. A toner image is formed on a second surface of the inverted sheet in the same way as in the above, and thereafter, is delivered onto the delivery tray 120.

Fixing Device

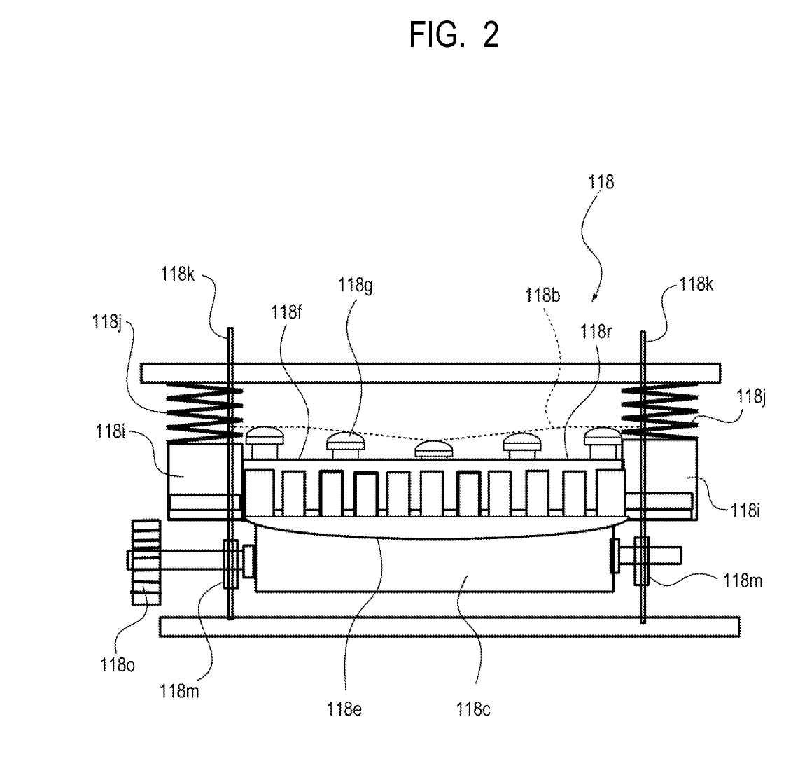

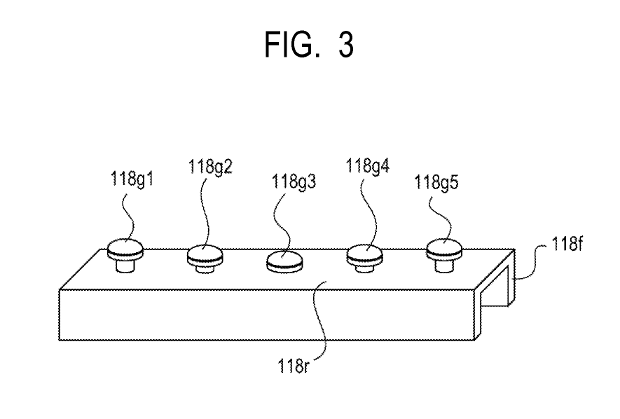

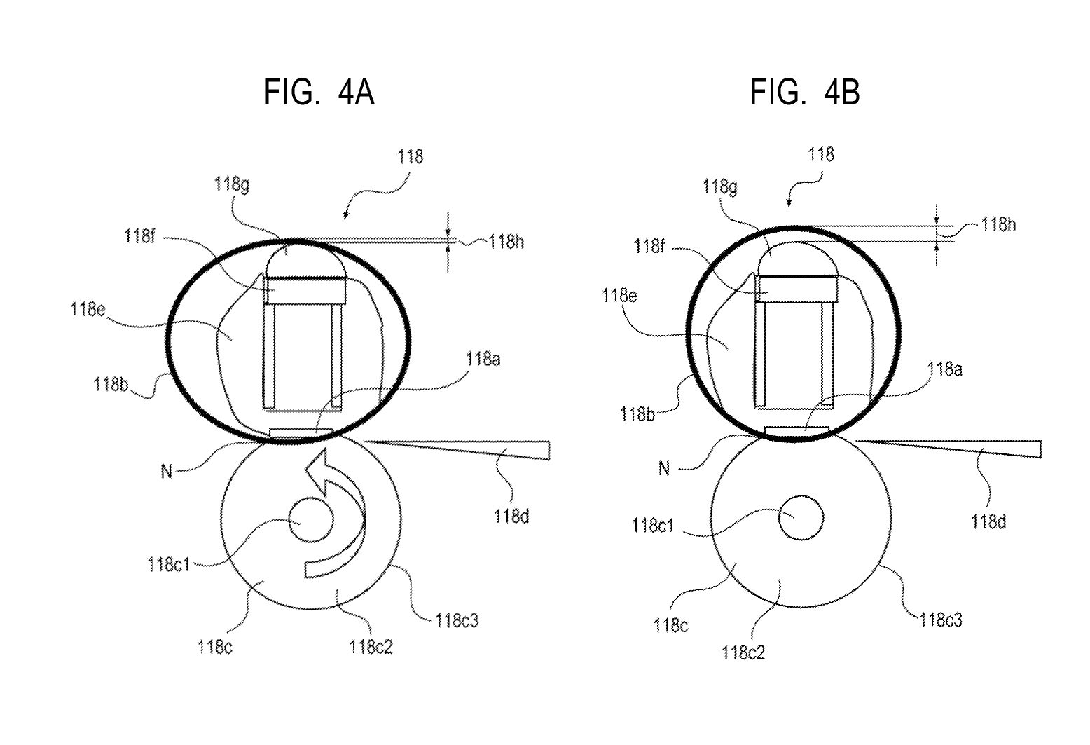

Next, a configuration of the fixing device 118 serving as a heating device is described with reference to FIGS. 2, 3, 4A, and 4B. FIG. 2 is a schematic front sectional view illustrating the configuration of the fixing device 118, and part of a fixing film 118b serving as a band-shaped rotation unit is represented by a broken line. FIG. 3 is a perspective explanatory diagram illustrating a configuration of protrusions 118g protruding from an upper surface 118r which is an outer circumferential surface of a heater stay 118f serving as a guide member for guiding the fixing film 118b. FIG. 4A is a schematic side sectional view illustrating a state of the fixing film 118b which is rotated in association with the rotation of a pressure roller 118c serving as a pressure member of the fixing device 118. FIG. 4B is a schematic side sectional view illustrating a state of the fixing film 118b during suspension of the pressure roller 118c serving as the pressure member of the fixing device 118.

The fixing device 118 illustrated in FIGS. 2, 4A, and 4B includes a heater 118a serving as a heat generator, and a film guide 118e serving as a guide member for supporting the heater 118a and guiding the fixing film 118b. The heater stay 118f holds the film guide 118e.

Further, the fixing device 118 includes the fixing film 118b in a tubular shape serving as a heating rotation member which slides and rotates around an outer circumference of the heater stay 118f and the film guide 118e, and the pressure roller 118c serving as a pressure member that rotates while coming into pressure-abutment against the outer circumferential surface of the fixing film 118b and rotates. The heater 118a is disposed on an inner side of the fixing film 118b.

The film guide 118e and the heater stay 118f for guiding the fixing film 118b serving as a rotation unit form a support unit. The fixing film 118b is formed as a band-shaped rotation unit which rotates around the support unit and heats a toner image formed on a sheet which is an object.

There is provided an inlet guide 118d. A region of the heater stay 118f serving as a guide member, which does not come into abutment against the pressure roller 118c serving as a pressure member through intermediation of the fixing film 118b, is considered. In that region, multiple protrusions 118g capable of coming into abutment against the inner circumferential surface of the fixing film 118b are fixed on the upper surface 118r which is an outer circumferential surface of the heater stay 118f along a longitudinal direction (right and left direction of FIG. 2) of the heater stay 118f. The upper surface 118r is a surface on an opposite side to a surface on which a fixing nip part N with respect to the pressure roller 118c is formed.

In the first embodiment, the upper surface 118r of the heater stay 118f is formed as a flat surface. The height of a protrusion 118g3, which is at a central part in the longitudinal direction (right and left direction of FIG. 2) of the heater stay 118f, from the upper surface 118r of the heater stay 118f is as follows. The height of the protrusion 118g3 in the central part from the upper surface 118r of the heater stay 118f is set so as to be smaller than that of protrusions 118g1, 118g5, which are on an end part side in the longitudinal direction (right and left direction of FIG. 2) of the heater stay 118f, from the upper surface 118r of the heater stay 118f.

A region of the heater stay 118f serving as a guide member, which does not come into abutment against the pressure roller 118c serving as a pressure member through intermediation of the fixing film 118b, is considered. A distance between the protrusion 118g3 in the central part in the longitudinal direction (right and left direction of FIG. 2) of the heater stay 118f and the inner circumferential surface of the fixing film 118b is considered. Further, a distance between the protrusions 118g1, 118g5 on the end part side which corresponds to a first region in the longitudinal direction (right and left direction of FIG. 2) of the heater stay 118f and the inner circumferential surface of the fixing film 118b is considered.

The distance between the protrusion 118g3 in the central part which is a second region positioned closer to the central part in the rotation axis direction than the first region and the inner circumferential surface of the fixing film 118b is set to be larger than that between the protrusions 118g1, 118g5 on the end part side and the inner circumferential surface of the fixing film 118b.

In FIGS. 2, 4A, and 4B, both ends of the heater stay 118f in the longitudinal direction (right and left direction of FIG. 2) and flange caps 118i are fitted with each other. A groove part (not shown) provided on a side surface of each flange cap 118i on each end part is fitted to an edge part of a slide groove part provided in a vertical direction on a side plate 118k serving as a frame body so as to be movable in the vertical direction of FIG. 2 along the slide groove part.

The upper surface of the flange cap 118i in each end part is urged by a pressure spring 118j. Consequently, the flange cap 118i, the heater stay 118f, the film guide 118e, and the heater 118a are brought into abutment against the pressure roller 118c through intermediation of the fixing film 118b in the stated order under a predetermined pressure force.

As illustrated in FIGS. 4A and 4B, the fixing film 118b and the pressure roller 118c form the fixing nip part N. A cored bar 118c1 serving as a rotation shaft of the pressure roller 118c is axially supported rotatably by a pressure roller bearing 118m fixed to the side plate 118k illustrated in FIG. 2 and is rotationally driven by a motor (not shown) via a drive gear 118o.

As illustrated in FIG. 4A, when the pressure roller 118c rotates, the fixing film 118b which is held in press-contact with the surface of the pressure roller 118c rotates in association therewith so as to slide around the outer circumferential surface of the film guide 118e. A sheet having the surface on which an unfixed toner image has been formed is nipped between the fixing film 118b and the pressure roller 118c and conveyed while being heated and pressurized.

In a transfer nip part formed by the photosensitive drum 112 and the transfer roller 115 illustrated in FIG. 1, the sheet having the surface onto which an unfixed toner image has been transferred is conveyed to the fixing nip part N along the inlet guide 118d illustrated in FIGS. 4A and 4B. The sheet is supplied with predetermined heat and pressure, with the result that the toner image is fixed onto the surface of the sheet, and thereafter the sheet is delivered out of the image forming apparatus main body A.

Heat Generator

In the first embodiment, the heater 118a serving as a heat generator is a heater obtained as follows. On an alumina (Al₂O₃) substrate having a thickness of 1 mm, a heat-generating resistor of silver (Ag) is screen-printed to have a predetermined width and thickness. Then, protective glass is coated on its surface. The heat generator thus obtained is fixed to the film guide 118e.

The heater 118a is fixed to and supported by the film guide 118e with the surface side thereof exposed downwardly. A thermister (not shown) is provided in contact with the back surface side of the heater 118a.

Guide Member

In the first embodiment, the film guide 118e, the heater stay 118f, and the protrusions 118g function as a guide member serving as a support unit. The film guide 118e serving as a guide member for guiding the fixing film 118b can be made of a phenol resin, a polyimide resin, a polyamide resin, a polyamide-imide resin, a polyetheretherketone (PEEK) resin, or a polyether sulfone (PES) resin.

Further, the film guide 118e is made of a material having satisfactory insulation and heat resistance such as a polyphenylene sulfide (PPS) resin, a fluorine resin, a liquid crystal polymer (LCP) resin, and a mixed resin thereof. As the material for the protrusions 118g, the same material as that of the guide member can be applied, and a material having satisfactory insulation and heat resistance is used.

As the material for the heater stay 118f serving as a guide member for guiding the fixing film 118b, a metal which is inexpensive and has high workability and excellent strength such as iron, stainless steel (SUS), and aluminum is used. The heater stay 118f is formed into a substantially U-shape in a cross-section as illustrated in FIG. 2 so as to be excellent in strength and to have small heat capacity, and further to contain a temperature detecting element and a safety element.

It is preferred that the heater stay 118f have a plate thickness capable of satisfying both the prevention of warp with respect to a pressure force and the reduction in heat capacity. Further, the heater stay 118f is formed so as to contain a temperature detecting member or the like as necessary. The outer circumferential surface of the protrusions 118g protruding on the upper surface 118r of the heater stay 118f and the inner circumferential surface of the fixing film 118b relatively slide on each other while being held in contact with each other.

Fixing Film

As the fixing film 118b serving as a rotation unit, a composite layer film can be used, which includes a base layer made of a resin material containing a heat-resistant component as a base or a metal material such as stainless steel (SUS), a heat-resistant elastic layer serving as an intermediate layer, and a releasing layer formed by covering the outer circumferential surface of the heat-resistant elastic layer with a fluorine resin. The fixing film 118b of the first embodiment is formed so as to have an outer diameter of 24 mm. Then, the fixing film 118b is brought into press-contact with the outer circumferential surface of the rotating pressure roller 118c so as to rotate in association with the rotating pressure roller 118c.

Pressure Member

The pressure roller 118c serving as a pressure member includes the cored bar 118c1 serving as a rotation shaft, a heat-resistant rubber elastic layer 118c2 provided on the outer circumferential surface of the cored bar 118c1, and a fluorine resin layer 118c3 provided on the outer circumferential surface of the heat-resistant rubber elastic layer 118c2. As a rubber material to be used for the heat-resistant rubber elastic layer 118c2, a heat-resistant ethylene propylene rubber, a silicone rubber, a fluorine rubber, or a rubber having a foam body (sponge) structure of the aforementioned rubbers can be applied.

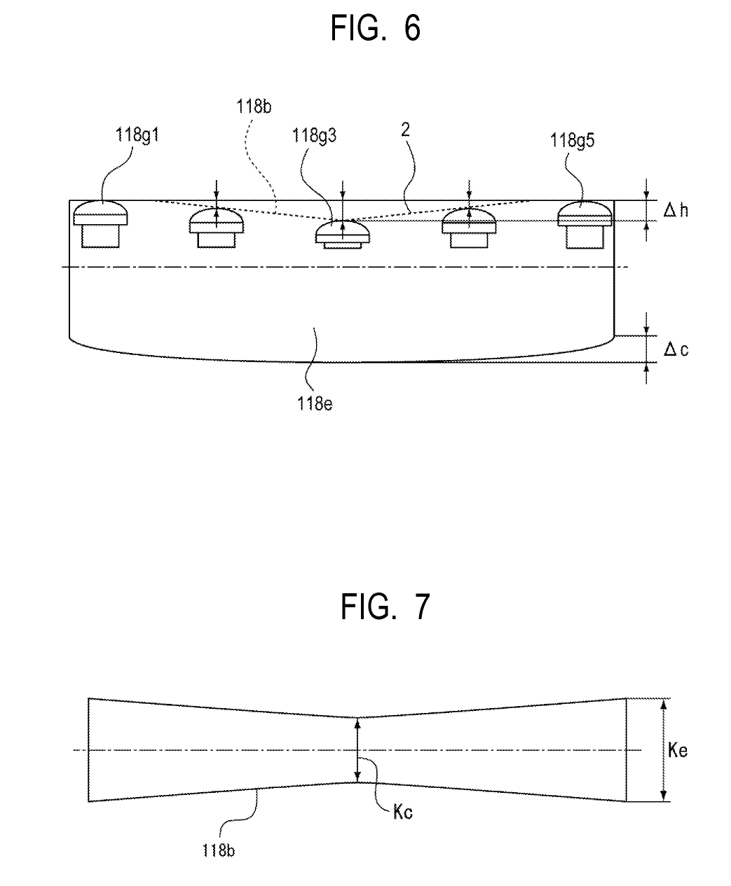

In the first embodiment, as illustrated in FIGS. 2 and 6, a region of the film guide 118e to be a guide member for guiding the fixing film 118b is formed into a crown shape, in which the outer diameter in the central part is larger than those in the end parts, along the longitudinal direction of the film guide 118e.

A dimension difference between the outer diameter in the end parts in the longitudinal direction of the crown-shaped film guide 118e and the outer diameter in the central part is set to Δc (0.3 mm in the first embodiment).

The protrusion 118g3, which is in the central part in the longitudinal direction of the heater stay 118f and is to be a guide member illustrated in FIG. 6, has the height of 1.00 mm from the upper surface 118r of the heater stay 118f in the first embodiment. The protrusions 118g1, 118g5, which are on the end parts side, have the height of 1.35 mm from the upper surface 118r of the heater stay 118f in the first embodiment. The dimension difference between the protrusion 118g3 and the protrusions 118g1, 118g5 in height is set to Δh (0.35 mm in the first embodiment).

As illustrated in FIG. 7, the fixing film 118b alone has a reversed crown shape in which an inner diameter Kc in the central part in the axial direction (right and left direction of FIG. 7) (central part in the rotation axis direction) of the fixing film 118b in a tubular shape is smaller than an inner diameter Ke thereof in the end parts. An inner diameter difference Δi between the inner diameter Ke in the end parts in the longitudinal direction (end parts in the rotation axis direction) of the fixing film 118b having a reversed crown shape and the inner diameter Kc thereof in the central part is set to 50 μm.

The inner diameter difference Δi, the inner diameter Ke, and the inner diameter Kc are represented by the following numerical expression 1.

Δi=Ke−Kc (Expression 1)

A relationship of the dimension difference Δh, the inner diameter difference Δi, and the dimension difference Δc illustrated in FIGS. 6 and 7 is as represented by the following numerical expression 2.

Δh>Δi+Δc (Expression 2)

Thus, during the suspension of the pressure roller 118c and the fixing film 118b illustrated in FIG. 4B, a gap 118h between the inner circumferential surface of the fixing film 118b and the guide surface of the guide member is set as follows. The guide surface of the guide member is formed of the film guide 118e, the heater stay 118f, and the protrusions 118g. The gap 118h (1.25 mm in the first embodiment) in the end part in the longitudinal direction of the fixing film 118b is set to be smaller than the gap 118h (1.5 mm in the first embodiment) in the central part.

FIG. 4A illustrates a state in which the fixing film 118b is rotationally driven by the pressure roller 118c, is brought into abutment against the pressure roller 118c and rotates in association therewith. The gap 118h is smaller than that illustrated in FIG. 4B in which the fixing film 118b is suspended. The rotating fixing film 118b and the protrusion 118g are held in contact with each other, and the gap 118h therebetween is 0.

Consequently, the rotating fixing film 118b can be prevented from warping in the longitudinal direction. Further, the gap 118h between the outer circumferential surface of the protrusions 118g1, 118g5 in the end parts in the longitudinal direction and the fixing film 118b is smaller than the gap 118h between the outer circumferential surface of the protrusion 118g3 in the central part in the longitudinal direction and the fixing film 118b, and the protrusions 118g1, 118g5 are higher than the protrusion 118g3. This increases the contact pressure on the end part side of the rotating fixing film 118b to increase the sliding resistance. That is, the sliding friction resistance in the end part which is the first region becomes larger than the sliding friction resistance on the central part side which is the second region. Thus, the retention force in the end parts of the fixing film 118b becomes large to suppress a bias force toward the central part in the longitudinal direction, which can prevent film overlapping.

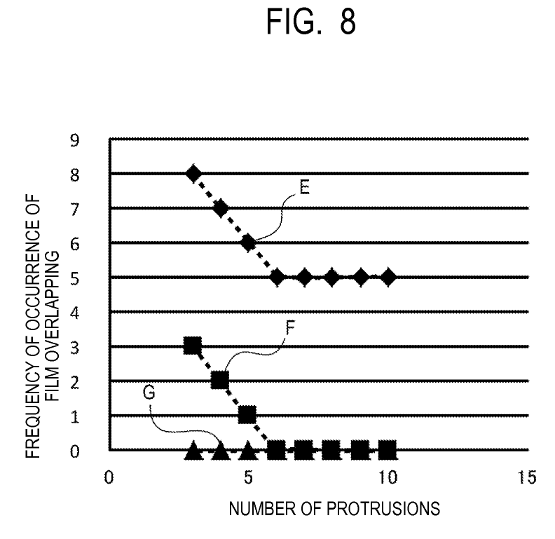

FIG. 8 illustrates the frequency of occurrence of film overlapping when, as an experimental condition, the fixing device 118 illustrated in FIG. 2 is rotated at 100 rpm while the temperature is controlled at 200° C. under an N/N environment (temperature: 23° C., humidity: 50%) and plain paper of an A3 size having a paper weight of 80 g is passed through the fixing device 118.

FIG. 8 illustrates the results obtained by conducting an experiment of the frequency of occurrence of film overlapping 10 times through use of the fixing film 118b having a thickness of 40 μm which is smaller than that of the ordinary fixing film and the fixing film 118b having a thickness of 70 μm which is the ordinary thickness, in order to clarify a relationship between the shape of the protrusion 118g and the film overlapping. The horizontal axis of FIG. 8 represents the number of the protrusions 118g protruding on the upper surface 118r of the heater stay 118f serving as a guide member, and the vertical axis represents the frequency of occurrence of film overlapping.

In Comparative Example E illustrated in FIG. 8, the thickness of the fixing film 118b is set to 40 μm, and the height of the multiple protrusions 118g from the upper surface 118r of the heater stay 118f is set to be identical (1.35 mm in Comparative Example E).

In Example F, the thickness of the fixing film 118b is set to 40 μm, and the height of the multiple protrusions 118g from the upper surface 118r of the heater stay 118f is smaller in the central part in the longitudinal direction of the heater stay 118f and increases gradually toward the end parts so that the protrusions 118g have a reversed crown shape.

For example, the height of the protrusions 118g from the upper surface 118r of the heater stay 118f in the case where the total number of the protrusions 118g is five is as follows. The height of the protrusion 118g is 1.35 mm in both the end parts in the longitudinal direction of the heater stay 118f, 1.0 mm in the central part, and 1.175 mm in regions between the central part and both the end parts.

In Example G, the thickness of the fixing film 118b is set to 70 μm, and the height of the multiple protrusions 118g from the upper surface 118r of the heater stay 118f is smaller in the central part in the longitudinal direction of the heater stay 118f and increases gradually toward the end parts so that the protrusions 118g have a reversed crown shape.

The frequency of occurrence of film overlapping is smaller in the case where the multiple protrusions 118g have a reversed crown shape as in Examples F and G of FIG. 8, compared to the case where the multiple protrusions 118g do not have a reversed crown shape or have a flat shape as in Comparative Example E. It is understood that there is an effect that the frequency of occurrence of film overlapping is reduced by increasing the number of the protrusions 118g, for example, by providing 4 or more protrusions 118g along the longitudinal direction of the heater stay 118f.

It is understood from Example G that film overlapping does not occur in the fixing film 118b under the following conditions: the thickness of the fixing film 118b is 70 μm which is the ordinary thickness; the protrusions 118g have a reversed crown shape in which the height increases gradually toward the end parts; and the number of the protrusions 118g is 3 or more.

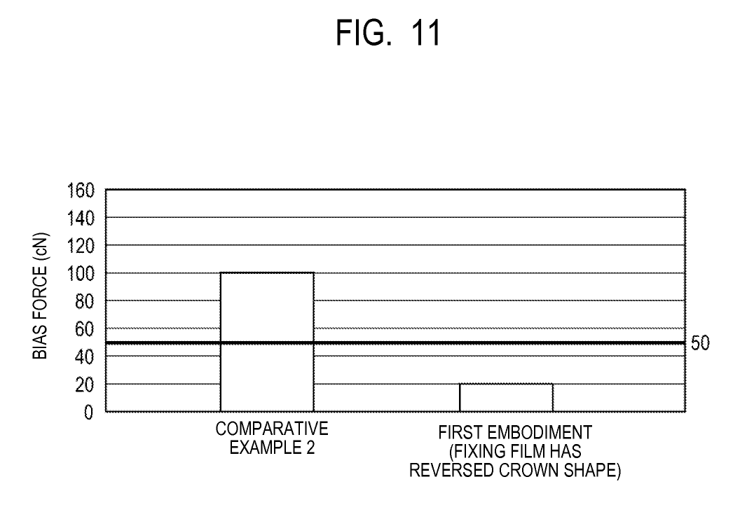

The right side of FIG. 11 illustrates the graph obtained by measuring a bias force (film overlapping force) in the central part in the longitudinal direction of the fixing film 118b through use of the first embodiment illustrated in FIGS. 3 and 7.

The heights of 5 protrusions 118g were set so that the shape formed by extending and connecting the outer circumferential surfaces of the 5 protrusions 118g provided on the upper surface 118r of the heater stay 118f according to the first embodiment illustrated in FIG. 3 became a reversed crown shape. Then, the fixing film 118b in a tubular shape having an inner diameter of a reversed crown shape illustrated in FIG. 7 slides and rotates around the outer circumference of the protrusions 118g.

The left side of FIG. 11 illustrates the graph of Comparative Example 2 (not shown) in which 5 protrusions 118g are provided on the upper surface 118r of the heater stay 118f as illustrated in FIG. 3, and the heights of the 5 protrusions 118g are set to be identical. The fixing film 118b in a tubular shape having an inner diameter of a reversed crown shape in the axial direction slides and rotates around the outer circumference of the protrusions 118g.

A design target value of a bias force in the central part in the longitudinal direction of the fixing film 118b, at which bias (film overlapping) does not occur, is experimentally determined to be 50 cN. In the configuration of Comparative Example 2 (not shown), the bias force was 100 cN with respect to the target value as illustrated in FIG. 11. On the other hand, in the configuration of the first embodiment illustrated in FIGS. 3 and 6, the bias force was 20 cN.

In the first embodiment, the bias force was equal to or less than 50 cN that is a bias force target value at which film overlapping does not occur. The bias force is reduced by increasing the number of the protrusions 118g provided on the upper surface 118r of the heater stay 118f. In order to set the bias force to be equal to or less than cN that is a bias force target value at which film overlapping does not occur, the heights of the 5 protrusions 118g are set so that the shape formed by extending and connecting the outer circumferential surfaces of the 5 protrusions 118g provided on the upper surface 118r of the heater stay 118f becomes a reversed crown shape.

FIG. 4A is a schematic sectional view illustrating a state in which the fixing film 118b is rotationally driven by the pressure roller 118c, is brought into abutment against the pressure roller 118c and rotates in association therewith. FIG. 4B is a schematic sectional view illustrating a state in which the pressure roller 118c and the fixing roller 118b are suspended. The gap 118h between the outer circumferential surface of the protrusions 118g and the inner circumferential surface of the fixing film 118b illustrated in FIGS. 4A and 4B influences the occurrence of wrinkles on a sheet. Therefore, it has been proposed to set the gap 118h to an arbitrary numerical value.

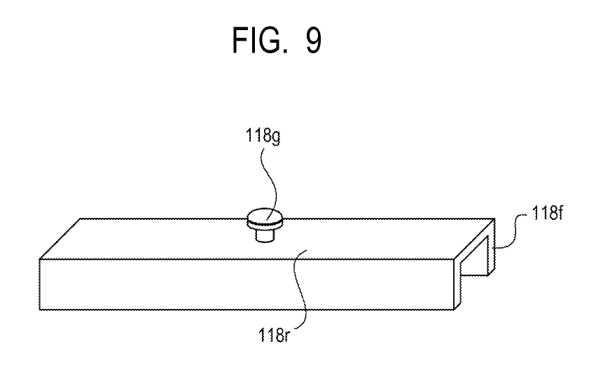

However, in Comparative Example 1 illustrated in FIG. 9, the magnitude of the gap 118h between the inner circumferential surface of the fixing film 118b and the outer circumferential surface of the protrusions 118g in the longitudinal direction of the fixing film 118b was not defined. Therefore, wrinkles occurred on a sheet, and film overlapping that is a phenomenon in which the fixing film 118b is biased to the center occurred.

FIG. 9 illustrates an example of the arrangement of the protrusions 118g of Comparative Example 1. In Comparative Example 1 illustrated in FIG. 9, the protrusion 118g having a height of 1.35 mm from the upper surface 118r was provided only at one position in the central part in the longitudinal direction of the upper surface 118r of the heater stay 118f.

In Comparative Example 1, when small-sized sheets pass through the fixing nip part N consecutively, the temperature of a non-sheet passing part in the longitudinal direction of the pressure roller 118c rises and the non-sheet passing part expands, with the result that the outer diameter of the pressure roller 118c in the non-sheet passing part becomes large. Therefore, the rotation speed of the fixing film 118b becomes higher in the non-sheet passing part than that in the sheet passing part in the longitudinal direction of the pressure roller 118c, and the fixing film 118b is distorted.

Consequently, in the sheet passing region, the fixing film 118b sags on an upstream side in the sheet conveyance direction (right side of FIGS. 4A and 4B) with respect to the fixing nip part N formed by the heater 118a and the pressure roller 118c. Then, a phenomenon occurs in which, a sheet is wrinkled by the resistance caused by the sagging of the fixing film 118b, when the leading edge of the sheet enters the fixing nip part N.

In Comparative Example 1 illustrated in FIG. 9, in order to prevent wrinkles from occurring, the protrusion 118g is provided in the vicinity of the central part in the longitudinal direction of the heater stay 118f. Consequently, a difference between the inner circumferential length of the fixing film 118b and the outer circumferential length of the guide member formed of the heater stay 118f including the protrusion 118g and the film guide 118e is reduced. When the warp amount of the fixing film 118b is reduced, wrinkles can be prevented from occurring on a sheet to some degree.

In Comparative Example 1 illustrated in FIG. 9, the protrusion 118g is added only in the vicinity of the central part in the longitudinal direction of the heater stay 118f. With the foregoing configuration, the gap 118h between the inner circumferential surface of the fixing film 118b in the central part in the longitudinal direction of the fixing film 118b and the guide surface of the guide member for supporting the fixing film 118b is smaller than the gap 118h between the inner circumferential surface of the fixing film 118b in the end parts in the longitudinal direction of the fixing film 118b and the guide surface of the guide member for supporting the fixing film 118b.

In the above-mentioned case, although the warping in the central part in the longitudinal direction of the fixing film 118b can be prevented from occurring by the protrusion 118g, a sheet contracts during heating due to the evaporation of moisture. Further, a sheet, to which the fixing is performed, takes heat from the thermally expanding fixing film 118b, with the result that the fixing film 118 contracts. In the above-mentioned case, no good effect against those phenomena is obtained and rather entails adverse effects.

The protrusion 118g3 is provided in the central part in the longitudinal direction of the heater stay 118f. Thus, the film guide 118e serving as a guide member for supporting the fixing film 118b has a region, which comes into abutment against the pressure roller 118c serving as a pressure member through intermediation of the fixing film 118b, and the region is formed into a crown shape. The crown shape refers to a shape in which the outer diameter is larger in the central part than those in the end parts along the longitudinal direction of the heater stay 118f. As a result, a phenomenon in which the fixing film 118b contracts in the central part in the longitudinal direction due to the passage of a sheet is accelerated.

In the first embodiment, as illustrated in FIG. 3, the height of the protrusion 118g3 in the central part in the longitudinal direction of the heater stay 118f from the upper surface 118r of the heater stay 118f is small. The height of the protrusion 118g3 in the central part from the upper surface 118r is 1.0 mm in FIG. 3. The heights of the protrusions 118g2, 118g4 provided on an outer side of the protrusion 118g3 so as to be adjacent thereto are 1.175 mm, respectively. The heights of the protrusions 118g1, 118g5 in both the end parts from the upper surface 118r are 1.35 mm, respectively.

The height of the protrusions 118g from the upper surface 118r of the heater stay 118f is set so as to increase gradually from the central part to both the end parts. Thus, the outer circumferential surface of the guide member for supporting the fixing film 118b has a reversed crown shape in which the outer diameter increases from the central part to the end parts in the longitudinal direction.

The arrangement of the protrusions 118g in the longitudinal direction of the heater stay 118f is formed into a reversed crown shape. With this arrangement, the gap 118h between the inner circumferential surface of the fixing film 118b in the central part in the longitudinal direction of the fixing film 118b and the guide surface of the guide member for supporting the fixing film 118b is set so as to be larger than the gap 118h between the inner circumferential surface of the fixing film 118b in both the end parts in the longitudinal direction of the fixing film 118b and the guide surface of the guide member for supporting the fixing film 118b.

The small gap 118h between the inner circumferential surface of the fixing film 118b and the outer circumferential surface of the protrusions 118g means a small difference between the inner circumferential length of the fixing film 118b and the outer circumferential length of the guide member formed of the film guide 118e, the heater stay 118f, and the protrusions 118g.

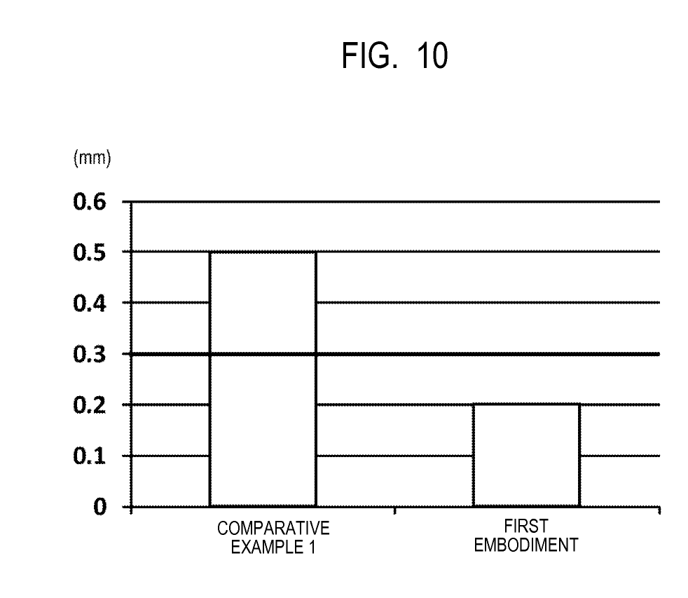

A method of measuring a bias amount illustrated in FIG. 10 is as follows. A difference (contraction amount) between the initial total length in the longitudinal direction of the fixing film 118b of the fixing device 118 and the total length in the longitudinal direction of the fixing film 118b after sheet passage was defined as a bias amount (amount of the fixing film 118b which is biased to the central part in the longitudinal direction), and a movement amount of the end part of the fixing film 118b was measured.

The measurement after sheet passage of the fixing film 118b of the fixing device 118 was performed as follows. The fixing device 118 was driven at a circumferential velocity of 100 mm/sec with the temperature of the fixing device 118 being controlled at 200° C. under an N/N environment, and 30 seconds later, one sheet of plain paper of an A3 size having a paper weight of 80 g was passed through the fixing device 118. Then, a contraction amount in the longitudinal direction of the fixing film 118b was measured.

The left side of FIG. 10 illustrates the graph obtained by measuring the movement amount of the end part in the longitudinal direction of the fixing film 118b as a bias amount through use of Comparative Example 1 illustrated in FIG. 9. The right side of FIG. 10 illustrates the graph obtained by measuring the movement amount of the fixing film 118b from the end part to the central part in the longitudinal direction as a bias amount through use of the first embodiment illustrated in FIG. 3.

A design target value of a bias amount, which does not cause bias in the end part in the longitudinal direction of the fixing film 118b (film overlapping), was experimentally determined to be 0.3 mm or less. In the configuration of Comparative Example 1 illustrated in FIG. 9, the bias amount was 0.5 mm as illustrated in FIG. 10. On the other hand, in the configuration of the first embodiment illustrated in FIG. 3, the bias amount was 0.2 mm. In the first embodiment, the bias amount was equal to or less than 0.3 mm that was a target value of the bias amount at which film overlapping does not occur.

The heights of the protrusions 118g on the end parts sides in the longitudinal direction of the fixing film 118b from the upper surface 118r of the heater stay 118f are set to be larger than that of the protrusion 118g in the central part. The bias of the fixing film 118b from the end part to the central part in the longitudinal direction is prevented by enhancing the friction force of the protrusion 118g with respect to the inner circumferential surface of the fixing film 118b.

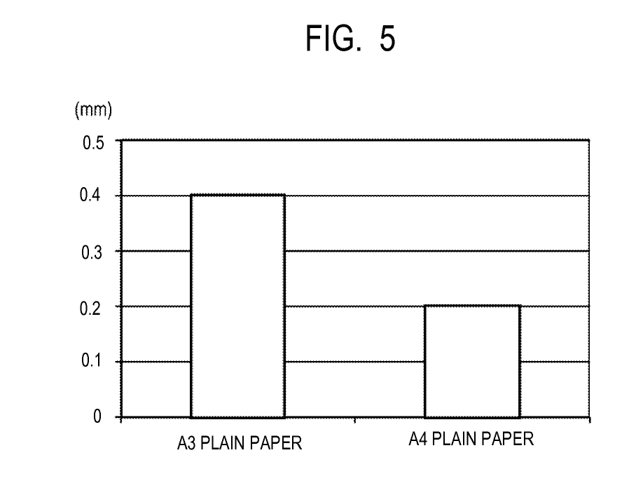

FIG. 5 illustrates a contraction amount of a sheet, which is a difference, between the length of a sheet in the longitudinal direction of the fixing film 118b before the sheet passes through the fixing device 118 and the length of the sheet after the sheet passes through the fixing device 118, in the case where the sheet is conveyed to the fixing device 118 whose temperature is controlled at 200° C. under an N/N environment. The left side of FIG. 5 illustrates the graph of the case of plain paper of an A3 size, and the contraction amount of the sheet was 0.4 mm. The right side of FIG. 5 illustrates the graph of the case of plain paper of an A4 size, and the contraction amount of the sheet was 0.2 mm. The A3-size plain paper is grain long, and the A4-size plain paper is grain short. Therefore, a difference occurs in contraction amount between those sheets. The contraction of a sheet occurs when the sheet is heated and moisture thereof is evaporated.

The sheet contraction amount illustrated in FIG. 5 and the bias amount of the fixing film 118b after sheet passage illustrated in FIG. 10 are compared to each other. The bias amount of the fixing film 118b after sheet passage illustrated in FIG. 10 is 0.5 mm in the configuration of Comparative Example 1 illustrated in FIG. 9 and is larger by 0.1 mm than 0.4 mm of the sheet contraction amount of the A3-size plain paper illustrated in FIG. 5. The difference corresponds to a value of contraction of the fixing film 118b itself after the sheet, to which the fixing is performed, takes heat from the fixing film 118b. Actually, it was confirmed that, when the fixing film 118b was cooled with a blast fan to the surface temperature of the fixing film 118b after sheet passage, the fixing film 118b itself contracted by about 0.1 mm even without sheet passage.

Film overlapping is caused when the contraction amount of a sheet exceeds the contraction amount of the fixing film 118b itself. Specifically, it can be considered as follows. When a sheet is heated and moisture thereof is evaporated, the sheet contracts and the fixing film 118b receives a friction force directed to the central part from the sheet. Then, the fixing film 118b is biased in the central direction, with result that film overlapping occurs.

In the first embodiment, as illustrated in FIG. 3, in one of contact regions which come into contact with the inner circumferential surface of the fixing film 118b serving as a rotatable rotation unit, one of the projections 118g1, 118g5 in both the end parts in the rotation axis direction of the fixing film 118b are present. The height (1.35 mm in the first embodiment) of the projections 118g1, 118g5 from the upper surface 118r of the heater stay 118f is set as follows. The height of the projections 118g1, 118g5 is set to be larger than that of the projection 118g3 (1.0 mm in the first embodiment) in the central part. Thus, in the contact regions, the sliding friction resistance between the fixing film 118b and the support member in the end parts in the rotation axis direction of the fixing film 118b at least becomes largest, which prevents film overlapping of the fixing film 118b.

In the first embodiment, the heights of the protrusions 118g arranged on the upper surface 118r of the heater stay 118f are varied between the end parts and the central part in the longitudinal direction. Alternatively, the upper surface 118r of the heater stay 118f is shaped so as to be higher in the end parts than in the central part, and thereby the end parts are positioned higher than the central part, without using the protrusions 118g. Then, the fixing film 118b is brought into direct contact with and slid on the upper surface 118r of the heater stay 118f during rotation of the fixing film 118b. In this way, the same effects as those of the above-mentioned first embodiment can be exhibited.

### Second Embodiment

In the first embodiment, the height of the protrusions 118g in the end parts in the longitudinal direction (right and left direction of FIG. 2) of the heater stay 118f from the upper surface 118r of the heater stay 118f is set to be larger than that of the protrusion 118g in the central part from the upper surface 118r of the heater stay 118f.

In contrast, in a second embodiment of the present invention, the sliding friction resistance between the inner circumferential surface of the fixing film 118b and the outer circumferential surface of the protrusions 118g is defined by changing the surface roughness of the protrusions without providing a difference between gaps in the end parts and the central part with respect to the projections 118g serving as a guide member. The remaining configuration is the same as that of the first embodiment, and hence the description thereof is omitted.

The sliding friction resistance of the protrusions in the end parts in the longitudinal direction (right and left direction of FIG. 2) of the heater stay 118f serving as a guide member is set to be larger than the sliding friction resistance of the protrusion in the central part in the longitudinal direction (right and left direction of FIG. 2) of the heater stay 118f. Thus, the retention force in the end parts of the fixing film 118b becomes large to suppress a bias force toward the central part in the longitudinal direction, which can prevent film overlapping and sheet wrinkles.

In order to achieve the above-mentioned configuration, the surface roughness (rougher than 10 μm in the second embodiment) of the outer circumferential surface of the projections 118g1, 118g5 in the end parts in the longitudinal direction (right and left direction of FIG. 2) of the heater stay 118f, which can come into abutment against the inner circumferential surface of the fixing film 118b, is set as follows. The surface roughness of the outer circumferential surface of the protrusions 118g1, 118g5 in the end parts is set to be larger and rougher than the surface roughness (smoother than 5 μm in the second embodiment) of the outer circumferential surface of the projection 118g3 in the central part in the longitudinal direction (right and left direction of FIG. 2) of the heater stay 118f, which can come into abutment against the inner circumferential surface of the fixing film 118b.

Consequently, the sliding friction resistance in the central part in the longitudinal direction (right and left direction of FIG. 2) of the fixing film 118b can be set smaller than the sliding friction resistance in the end parts in the longitudinal direction (right and left direction of FIG. 2) of the fixing film 118b.

Further, in the contact regions in which the inner circumferential surface of the rotating fixing film 118b and the outer circumferential surface of the support member come into contact with each other, the sliding friction resistance in the end parts in the rotation axis direction of the fixing film 118b at least becomes largest. This increases the retention force that retains the fixing film 118b in the end parts in the rotation axis direction to suppress a bias force toward the central part in the longitudinal direction, which can prevent film overlapping and sheet wrinkles.

In the second embodiment, the difference between the sliding friction resistance in the central part and the sliding friction resistance in the end parts is defined by the surface roughness of the protrusions. However, the present invention is not limited thereto. At least one surface on the end part side of the inner circumferential surface of the rotation unit and the outer circumferential surface of the support unit which come into contact with each other may be roughened. For example, the surface roughness in the end part of the inner circumferential surface of the fixing film 118b is set to be larger than that in the central part. Although the difference in sliding friction resistance is defined by the surface roughness of the contact part, the difference between the sliding friction resistance in the central part and the sliding friction resistance in the end parts may be caused by coating the protrusion in the central part with a lubricant such as grease.

Film overlapping and sheet wrinkles may be prevented by combining the first embodiment described above with the second embodiment. Although the rotation member serving as a rotation unit is described through use of the fixing film, the rotation member is not limited to a film, and a belt-shaped rotation member may be applied.

In the heating device of the present invention, the gap in the longitudinal direction (rotation axis direction) between the inner circumferential surface of the fixing film and the guide surface of the guide member for guiding the fixing film is set to be small. Further, the gap in the end parts in the longitudinal direction (rotation axis direction) between the fixing film and the guide member is set to be smaller than the gap in the central part in the longitudinal direction (rotation axis direction) between the fixing film and the guide member. This can prevent warping of the rotating fixing film and suppress a bias force of the fixing film toward the center in the longitudinal direction (center in the rotation axis direction) caused by the sliding friction resistance between the guide member and the fixing film in the end parts in the longitudinal direction (end parts in the rotation axis direction) of the rotating fixing film. Consequently, wrinkles can be prevented from being occurred on a sheet, and film overlapping can also be prevented.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2012-284326, filed Dec. 27, 2012, and No. 2013-235527, filed Nov. 14, 2013 which are hereby incorporated by reference herein in their entirety.

What is claimed is:

1. A heating device, comprising:
a support unit; and
a rotation unit having a band shape, rotating around the support unit, and heating an object,
wherein a sliding friction resistance in a rotation axis direction of the rotation unit between the rotation unit and the support unit is set so that at least a sliding friction resistance in a first region in the rotation axis direction is larger than a sliding friction resistance in a second region closer to a central part in the rotation axis direction than the first region.

2. A heating device according to claim 1, wherein a gap between an inner circumferential surface of the rotation unit and the support unit in the first region is smaller than a gap between the inner circumferential surface of the rotation unit and the support unit in the second region.

3. A heating device according to claim 1, wherein the first region is an end part in the rotation axis direction of the rotation unit and the second region is a central part in the rotation axis direction of the rotation unit.

4. A heating device according to claim 3, further comprising a pressure member that rotates while coming into pressure-abutment against the rotation unit,
wherein the support unit has a guide member guiding the rotation unit, and
wherein, in a region of the guide member, which is not abutting against the pressure member through intermediation of the rotation unit, a distance between a guide surface of the guide member and an inner circumferential surface in the second region is set to be larger than a distance between the guide surface of the guide member and an inner circumferential surface in the first region.

5. A heating device according to claim 4, further comprising:
multiple protrusions capable of coming into abutment against the inner circumferential surface of the rotation unit, the multiple protrusions being provided on an outer circumferential surface of the guide member in the region which is not abutting against the pressure member,
wherein a height of a protrusion of the multiple protrusions in an end part in the rotation axis direction of the guide member is larger than a height of a protrusion of the multiple protrusions in a central part in the rotation axis direction of the guide member.

6. A heating device according to claim 5,
wherein a region of the guide member, which comes into abutment against the pressure member through intermediation of the rotation unit, has a crown shape in which an outer diameter in the central part of the guide member becomes larger than an outer diameter in the end part of the guide member along the rotation axis direction of the guide member, and
wherein a dimension difference of the crown shape between the outer diameter in the end part of the guide member and the outer diameter in the central part of the guide member is set to be smaller than a dimension difference between the height of the protrusion in the central part of the guide member and the height of the protrusion in the end part of the guide member.

7. A heating device according to claim 5,
wherein a region of the guide member, which comes into abutment against the pressure member through intermediation of the rotation unit, has a crown shape in which an outer diameter in the central part of the guide member becomes larger than an outer diameter in the end part of the guide member along the rotation axis direction of the guide member,
wherein the rotation unit has a reversed crown shape in which an inner diameter in the second region is smaller than an inner diameter in the first region, and
wherein a sum of a dimension difference of the crown shape between the outer diameter in the end part of the guide member and the outer diameter in the central part of the guide member and an inner diameter difference between the second region and the first region is set to be smaller than a dimension difference between the height of the protrusion in the central part of the guide member and the height of the protrusion in the end part of the guide member.

8. A heating device according to claim 1, wherein, in at least one of an inner circumferential surface of the rotation unit or an outer circumferential surface of the support unit that come into contact with each other, a surface in the first region is rougher than a surface in the second region.

9. A heating device according to claim 8, further comprising a pressure member that rotates while coming into contact against the rotation unit,
wherein the support unit has a guide member guiding the rotation unit,
wherein multiple protrusions capable of coming into abutment against the inner circumferential surface of the rotation unit are provided on an outer circumferential surface of the guide member along the rotation axis direction of the guide member, and
wherein a surface of a protrusion of the multiple protrusions in an end part in the rotation axis direction of the guide member is rougher than a surface of a protrusion of the multiple protrusions in a central part in the rotation axis direction of the guide member.

10. A fixing device for fixing a toner image onto a sheet, comprising the heating device according to claim 1.

11. An image forming apparatus for forming an image on a sheet, comprising an image forming part having the heating device according to claim 1.
